(19) United States
(12) Patent Application Publication
(10) Pub. No.: US 2009/0306813 A1
(43) Pub. Date: Dec. 10, 2009

(54) Shipping Equipment

(76) Inventor: Jy Young AN, Daegu (KR)

Correspondence Address: AMPACC LAW GROUP, 3500 188th St. SW, Lynnwood, WA, 98037, US

(21) Appl. No.: 12/473,194

(22) Filed: May 27, 2009

(30) Foreign Application Priority Data
Jun. 5, 2008 (KR) 10-2008-0053068

(51) Int. Cl. G06F 19/00

(52) U.S. Cl. 700/218

(57) ABSTRACT

Disclosed is an apparatus for transferring products packaged and stacked in a factory or manufacturing spots, the apparatus including a packaged product for stacking frame stacking packaged products in a multiple stage, a packaged product extracting device for extracting the packaged products stacked in the packaged product stacking frame, a conveyor device for transferring the packaged product extracted by the packaged product extracting device to a certain position and a control device for actuating the packaged product extracting device, wherein the packaged products transfer apparatus first pushes a lowest-stage placed product among packaged products stacked in a certain height to a conveyor device, thereby firstly transferring and shipping a packaged product stacked in the lower stage of the product stacking rack that are manufactured formerly.

### TECHNICAL FIELD

The present invention relates to an apparatus for transferring products packaged and stacked in a factory or manufacturing spots, more particularly to an apparatus for transferring packaged products, which can easily push a lowest-stage placed product of a product-stacking rack among the whole packaged products stacked in a certain height into a conveyor belt, so that the stacked products can be unloaded according to the order of stacking.

### BACKGROUND ART

In general, a factory or a manufacturing spot manufactures products, then receives the manufactured products in a package such as a box, and transfers and/or ships them into an ordinary warehouse, a physical distribution center or agencies.

During this product transferring procedure, the manufactured product may be received and moved in a package such as a box, in which the vast majority of the packaged products are moved/transferred from one place to another by a conveyor device, etc. Then, the packaged product moved/transferred using the conveyor device may be piled up at a certain position, in the form of a multiple stage according to the moved order for a subsequent appropriate shipment and delivery, as necessary.

### DISCLOSURE

### [Technical Problem]

In the previous art, if packaged products are piled up at a certain height in a multiple stage to be transferred to a transfer apparatus, etc., the transfer procedure generally was initiated from the top one in terms of the stacked structure. As a result, a lowest-stage placed packaged product that was manufactured at earlier times among others was often shipped and sold rather later.

The present invention has been made in view of the above-mentioned problems, and an object of the present invention is to transfer, that is load and ship, a lowest-stage placed packaged product at first into a transport vehicle in order to firstly shipping a formerly manufactured product, when packaged products that are manufactured in a factory or manufacturing spots, packaged with a package, and then stacked and stored in a physical distribution center are to be loaded and shipped into the vehicle according to a product shipping request.

### [Technical Solution]

In accordance with one aspect of the present invention, there is provided an apparatus including a packaged product stacking frame 12 for stacking packaged products 11 in a multiple stage, a packaged product extracting device 13 for extracting the packaged products 11 stacked in the packaged product stacking frame 12, a conveyor device 14 for transferring the packaged product 11 extracted using the packaged product extracting device 13 to a certain position and a control device 15 for actuating the packaged product extracting device 13.

More particularly, the packaged product stacking frame 12 includes a stacking guide part 121 stacking the packaged product 11 in a multiple stage, a bottom part 122 formed of a locking jaw to stack the packaged product 11 and a supporting part 123 supporting the bottom part 122 to a certain height, the packaged product extracting device 13 includes an extracting guide 131 pushing the back side of the packaged product 11 to be extracted and a guide actuating part 133 having a receiving part 132 receiving the extracting guide 131 into the inner portion, and furthermore, the extracting guide 131 is structured to actuate in both upward and downward directions by means of a top/bottom actuating cylinder 134 in the receiving part 132 of the guide actuating part 133, and the guide actuating part 133 is structured to actuate in both forward and backward directions by means of a front/back actuating cylinder 135.

### [Advantageous Effects]

Therefore, the present invention can first push/transfer a lowest-stage placed product among packaged products stacked in a certain height to a conveyor device, thereby firstly transferring and shipping a packaged product stacked in the lower stage that are manufactured formerly and thus efficiently managing the manufacture and shipment of packaged products.

### BRIEF DESCRIPTION OF THE DRAWINGS

The above and other objects, features and advantages of the present invention will become more apparent from the following detailed description taken in conjunction with the accompanying drawings, in which:

FIG. 1 is a perspective view of a transfer apparatus of packaged products according to the present invention;

FIG. 2 is a schematic cross sectional view showing a transfer apparatus of packaged products according to the present invention;

FIG. 3 is a perspective view showing the extraction/transfer of packaged products by actuation of a transfer apparatus of packaged products according to the present invention;

FIG. 4 is another perspective view showing the extraction/transfer of packaged products by actuation of a transfer apparatus of packaged products according to the present invention; and

FIG. 5 is another perspective view showing packaged products which is transferred and then safely arrived by a transfer apparatus of packaged products according to the present invention.

### BEST MODE

### [Mode for Invention]

Hereinafter, preferred embodiments of the present invention will be described with reference to the accompanying drawings.

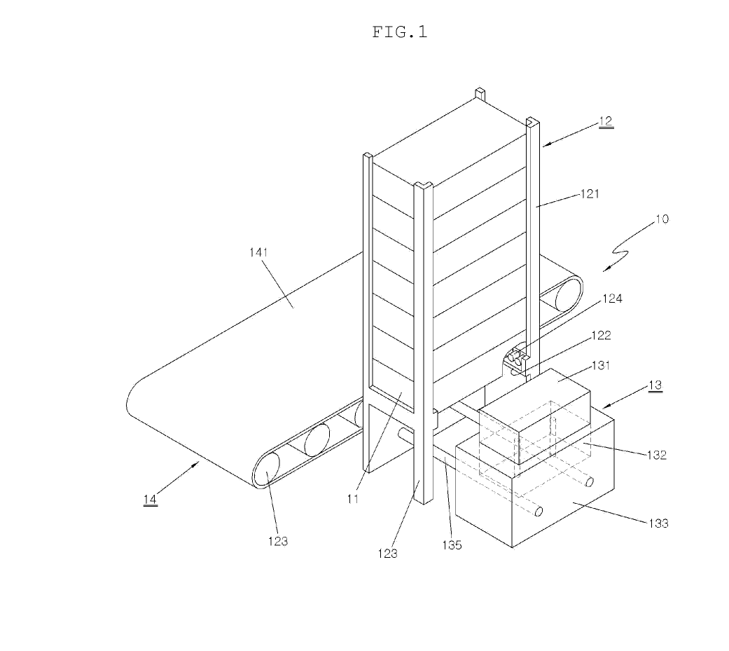

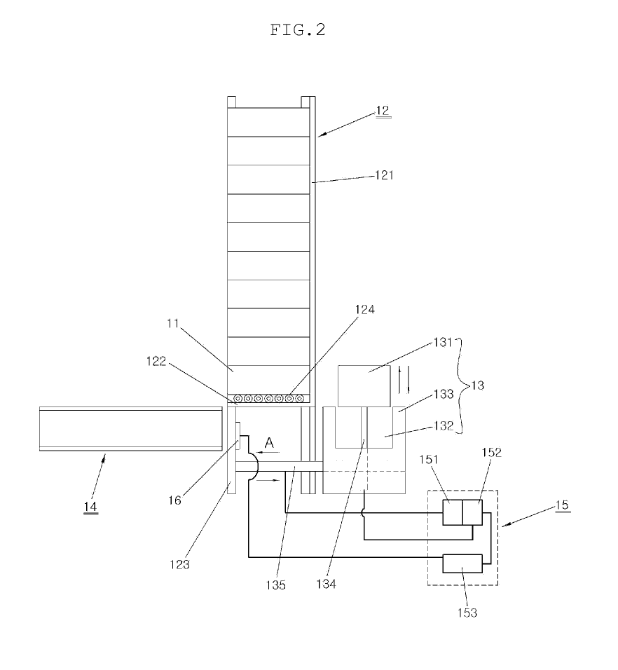

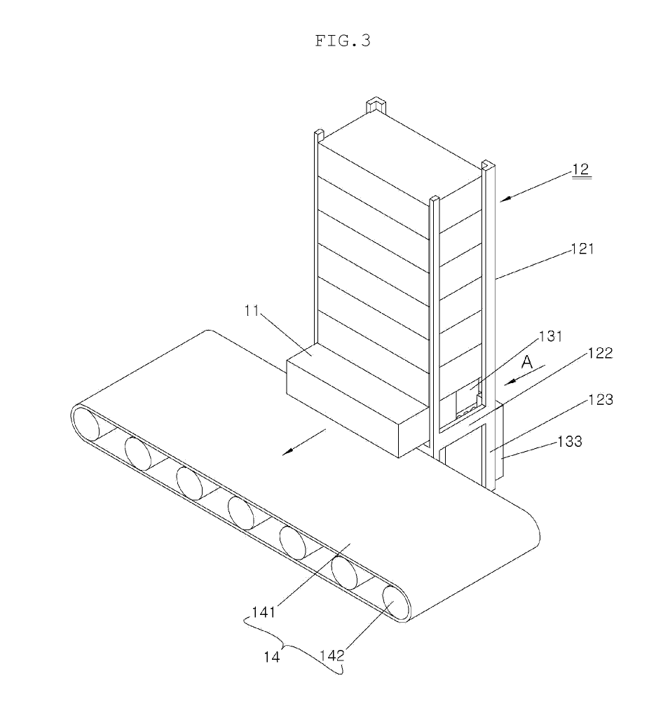

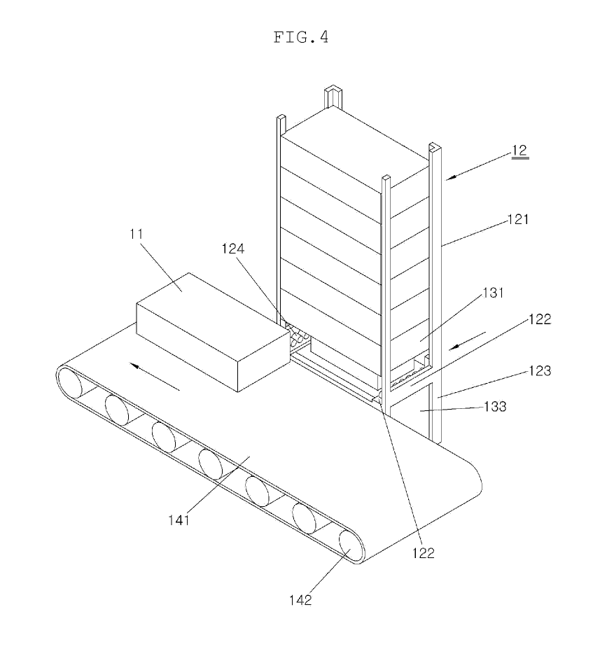

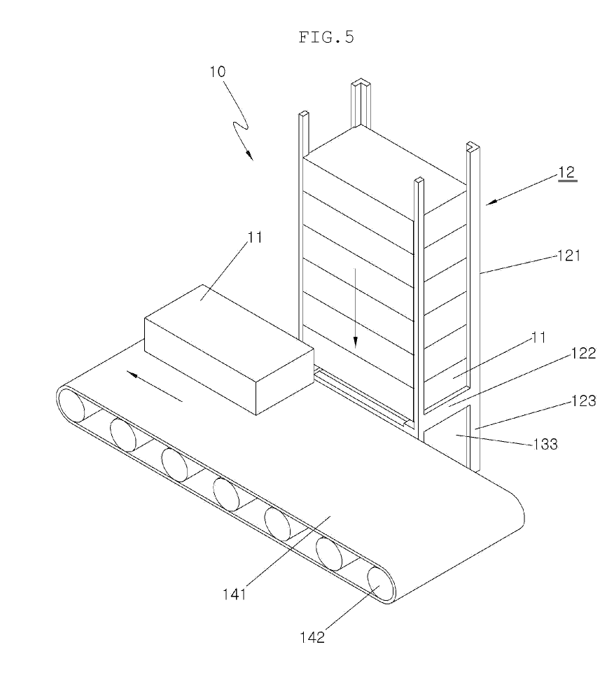

FIG. 1 is a perspective view of a transfer apparatus of packaged products according to the present invention, FIG. 2 is a schematic cross sectional view showing a transfer apparatus of packaged products according to the present invention, FIG. 3 is another perspective view showing the extraction/transfer of packaged products by actuation of a transfer apparatus of packaged products according to the present invention, FIG. 4 is another perspective view showing the extraction/transfer of packaged products by actuation of a transfer apparatus of packaged products according to the present invention and FIG. 5 is another perspective view showing packaged products which are transferred and also safely arrived by a transfer apparatus of packaged products according to the present invention.

A transfer apparatus of packaged products 10 according to the present invention will be described with reference to FIGS. 1 and 2. The apparatus includes a packaged product stacking frame 12 stacking packaged products 11 obtained by packaging a product manufactured in manufacturing spots with a package such as a box, a packaged product extracting device 13 extracting by pushing the packaged products 11 stacked in the packaged product stacking frame 12, a conveyor device 14 transferring the packaged product 11 extracted by the extracting device 13 to a certain position and a control device 15 actuating the packaged product extracting device 13.

More particularly, the packaged product stacking frame 12 includes a stacking guide part 121 stacking a packaged products 11 in a multiple stage, a bottom part 122 formed of a locking jaw to stack the packaged products 11 and a supporting part 123 supporting the bottom part 122 to a certain height, wherein the bottom part 122 includes rollers 124 formed at both sides thereof to easily push and thus move the packaged product 11.

The packaged product extracting device 13 includes an extracting guide 131 pushing the back side of the packaged product 11 to be extracted and a guide actuating part 133 having a receiving part 132 receiving/mounting the extracting guide 131 into the inner portion, wherein the extracting guide 131 is structured to actuate in both upward and downward directions by means of a top/bottom actuating cylinder 134 in the receiving part 132 of the guide actuating part 133, and the guide actuating part 133 is structured to actuate in both forward and backward directions by means of a front/back actuating cylinder 135.

Also, the conveyor device 14 includes a conveyor belt 141 and a rotary roller 142 both driven by a driving device (not shown), so that the packaged products 11 put into the conveyor belt 141 can be transferred to ship equipment such as a vehicle.

Furthermore, a detecting sensor 16 may be installed at one side of the supporting part 123 positioned in the lower side of the packaged product stacking frame 12 to detect contacting of the guide actuating part 133. Therefore, as the guide actuating part 133 forwards to the position of a detecting sensor 16 by means of the front/back actuating cylinder 135, the detecting sensor 16 can detect the movement of the guide actuating part 133 in order to stop the actuation of the front/back actuating cylinder 135.

The control part 15 includes a top/bottom actuating cylinder control valve 151 actuating the top/bottom actuating cylinder 134, a front/back actuating cylinder control valve 152 actuating the front/back actuating cylinder 135 and a detecting part 153 cognizant of signals from the detecting sensor 16.

Here, it is obvious that the top/bottom actuating cylinder 134 and its valve 151 as well as the front/back actuating cylinder 135 and its valve 152 may be constructed by using an air pressure system or an oil pressure system, and their installation and actuation mechanisms can be implemented using well-known technologies. The detecting sensor 16 and the detecting part 153 are also constructed by using a general common knowledge technology.

In the following, the operating principle of a transfer apparatus 10 of the present invention having the above-mentioned construction will be described.

As shown in FIG. 3, in order to extract packaged products 11 stacked in the stacking guide 121 of the packaged product stacking frame 12 in a multiple stage and also transfer them to the conveyor device 14 having the conveyor belt 141, the front/back actuating cylinder control valve 152 placed in the control part 15 is actuated, thereby forwarding the front/back actuating cylinder 135 to the arrow “A” direction and then moving the guide actuating part 133 of the packaged product extracting device 13. Then, the extracting guide 131 protruding out of the top side of the guide actuating part 133 forwards slightly to the arrow “A” direction, in the end pushing the packaged product 11 (see FIG. 3). At this time, the packaged products 11 may be easily pushed by means of the rollers 124 placed in the bottom part 122.

Subsequently, the packaged product 11 will be extracted and dropped over the conveyor belt 141 by the extracting guide 131 according to the transfer of the guide actuating part 133 as shown in FIG. 4. At this moment, the front/back actuating cylinder 135 may contact the detecting sensor 16 and then will be stopped. Next, the top/bottom actuating cylinder 134 will be actuated by actuation of the top/bottom actuating cylinder control valve 151, and accordingly, the extracting guide 131 will move towards its lower part and be received in the receiving part 132 of the guide actuating part 133 as shown in FIG. 5.

Next, when the extracting guide 131 is received into the receiving part 132, another packaged product 11 will be pushed down and then safely arrived in the rollers 124 and thus wait for extraction as shown in FIG. 5.

Subsequently, as the front/back actuating cylinder control valve 152 is actuated according to detection of the detection part 153, the front/back actuating cylinder 135 will move back. Also, as the guide actuating part 133 is moved back according to the backward motion of the front/back actuating cylinder 135, the extraction guide 131 placed in the guide actuating part 133 will protrude upward to be set in a position capable of extracting the packaged product 11 according to actuation of the top/bottom actuating cylinder 134.

As described above, as the guide actuating part 133 forwards, the packaged product 11 may be extracted to the conveyor belt 141 by the extracting guide 131 placed in the guide actuating part 133. Then, as the extracting guide 131 lowers, the packaged product descends and waits for extraction. Next, as the guide actuating part 133 moves back, the extracting guide 131 will ascend again and be set to extract the packaged product 11. A series of operations can be implemented by the control part 15, and it is obvious that the used mechanism can be constructed by the corresponding technologies or well-known technologies.

Therefore, the present invention enables products that are usually manufactured in a factory or manufacturing spots, packaged by a package such as a box and then stacked in a physical distribution center, etc. to be transferred/transported to any suitable ship equipment quickly and with ease according to the manufactured order, thereby facilitating a shipment procedure and improving work efficiency.

1. A transfer apparatus for shipping packaged products using a conveyor device, comprising:
a packaged product stacking frame for stacking packaged products in a multiple stage;
a packaged product extracting device for extracting the packaged products stacked in the packaged product stacking frame;
the conveyor device for transferring the packaged product extracted using the packaged product extracting device to a certain position; and
a control device for actuating the packaged product extracting device,
wherein the packaged product stacking frame comprises a stacking guide part stacking the packaged product in a multiple stage, a bottom part formed of a locking jaw to stack the packaged product and a supporting part supporting the bottom part to a certain height, and
the packaged product extracting device comprises an extracting guide pushing the back side of the packaged product to be extracted and a guide actuating part having a receiving part receiving the extracting guide into the inner portion, the extracting guide being configured to actuate in both upward and downward directions using a top/bottom actuating cylinder in the receiving part of the guide actuating part, and the guide actuating part being configured to actuate in both forward and backward directions using a front/back actuating cylinder.

2. The transfer apparatus of claim 1, wherein the bottom part of the packaged product stacking frame comprises rollers formed on both sides thereof to push and move the packaged product and the supporting part of the packaged product stacking frame comprises a detecting sensor on the front side thereof to detect the forward movement of the guide actuating part of the extracting device.
